(19) United States
(12) Patent Application Publication
(10) Pub. No.: US 2014/0344643 A1
(43) Pub. Date: Nov. 20, 2014

(54) HYBRID MEMORY PROTECTION METHOD AND APPARATUS

(71) Applicant: John H. HUGHES, Jr., Morgan Hill, CA (US)

(72) Inventor: John H. HUGHES, Jr., Morgan Hill, CA (US)

(21) Appl. No.: 14/029,709

(22) Filed: Sep. 17, 2013

Related U.S. Application Data
(60) Provisional application No. 61/823,286, filed on May 14, 2013.

(51) Int. Cl. G06F 11/10

(52) U.S. Cl. CPC G06F 11/10
USPC 714/763

(57) ABSTRACT

According to one general aspect, an apparatus may include a data word storage, and an error correction code generator. The data word storage may be configured to store a word of data, parity bits, and a partial word flag. The partial write flag may be configured to indicate whether a previous write operation was a full write or a partial write to the word of data. The ECC generator may be configured to dynamically generate an ECC during a write operation. If the write operation includes a full write to the word of data, the ECC generator may be configured to generate a first ECC based, at least in part, upon the word of data, the plurality of parity bits, and the partial word flag. If the write operation includes a partial write to the word of data, the ECC generator may be configured to generate a second ECC.

### TECHNICAL FIELD

This description relates to storing information, and more specifically to storing information in a way that reduces or ameliorates data errors.

### BACKGROUND

Modern semiconductor memory devices often use error checking and error correction bits to provide a reliable storage means for processors or other components. Generally, error-correcting code memory (ECC memory) is a type of computer data storage that may detect and/or correct the most common kinds of internal data corruption. ECC memory is used in most computers where data corruption cannot be tolerated under any circumstances, such as for scientific or financial computing.

Ideally, ECC memory creates a memory system in which the data that is read from each word or memory location is always the same as the data that had been written to it, even if a single bit actually stored, or more in some cases, has been flipped or changed to the wrong state (e.g., a “1” to a “0”, etc.). Traditionally a method of providing that memory protection is to use a Hamming code that is calculated based on the data portion of each memory word, typically 32 or 64 bits wide. Often, the Hamming code is chosen such that it can correct single bit errors in the memory word, and detect up to two total memory bits in error.

Some non-ECC memory with parity support allows errors to be detected, but not corrected; otherwise errors are not detected. In such a system, one or more extra bits of data are added to a memory. These extra bits indicate whether or not the actual or subject data includes an even or odd number of “1”s. Generally, with such a system the flipping of a single-bit within the actual data may be detected but not corrected.

Often the ECC code word or parity bit(s) are stored and fetched in parallel with the data word and the check is generated (for writes) and/or verified (for reads) as the memory access takes place. Generally, an immediate or substantially immediate correction or detection of errors is possible.

### SUMMARY

According to one general aspect, an apparatus may include a data word storage, and an error correction code generator. The data word storage may be configured to store a word of data, a plurality of parity bits, and a partial word flag. The word of data may be subdivided into portions of data. Each parity bit may be associated with a respective portion of data. The partial write flag may be configured to indicate whether or not a previous write operation was a full write to the word of data or a partial write to the word of data. The error correction code generator may be configured to dynamically generate an error correction code (ECC) during a write operation to the data word storage. If the write operation includes a full write to the word of data, the ECC generator may be configured to generate a first error correction code based, at least in part, upon the word of data, the plurality of parity bits, and the partial word flag. If the write operation includes a partial write to the word of data, the ECC generator may be configured to generate a second error correction code.

According to another general aspect, a method may include receiving a write operation command, wherein the write operation command instructs a memory to store at least a portion of a data word. The method may include storing at least a portion of the data word, wherein the data word is subdivided into portions of data. The method may include determining if the write operation includes either a full write to the data word, or a partial write to only a portion of the data word. The method may further include if the write operation includes a full write to the data word, dynamically generating a first error correction code based upon, at least, the data word. The method may include, if the write operation includes a partial write to the data word, generating at least one parity bit for each portion of the data word that is being stored. The method may include writing a partial write flag to indicate whether the write operation includes either a full write to the data word, or a partial write to only a portion of the data word.

According to another general aspect, a system may include a processor and a memory. The processor may be configured to execute one or more instructions and employ one or more data structures. The memory may be configured to store the one or more data structures in data words, wherein each data word is subdivided into portions of data. The memory may include an error correction code generator configured to dynamically generate an error correction code (ECC) associated with the data word during a write operation. The error correction code generator may be configured to, if the write operation includes a full write to a data word, generate a first error correction code based upon a first set of inputs, and, if the write operation includes a partial write to only a portion of the data word, generate a second error correction code based upon a second set of inputs. The memory may include a party bit generator configured to generate a plurality of parity bits, each parity bit associated with a respective portion of data. The memory may include a memory storage configured to store, for each data word the respective data word, the error correction code, the party bits, and a partial write flag configured to indicate whether or not a previous write operation was a full write of the data word or a partial write of the data word.

The details of one or more implementations are set forth in the accompanying drawings and the description below. Other features will be apparent from the description and drawings, and from the claims.

A system and/or method for storing and retrieving information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a series of data structures in accordance with the disclosed subject matter.

FIG. 3 is a flowchart of an example embodiment of a technique in accordance with the disclosed subject matter.

FIG. 4 is a block diagram of an example embodiment of a device configured to read data from a memory in accordance with the disclosed subject matter.

FIG. 5 is a flowchart of a second example embodiment of a technique in accordance with the disclosed subject matter.

FIG. 6 is a schematic block diagram of an information processing system which may include devices formed according to principles of the disclosed subject matter.

Like reference symbols in the various drawings indicate like elements.

### DETAILED DESCRIPTION

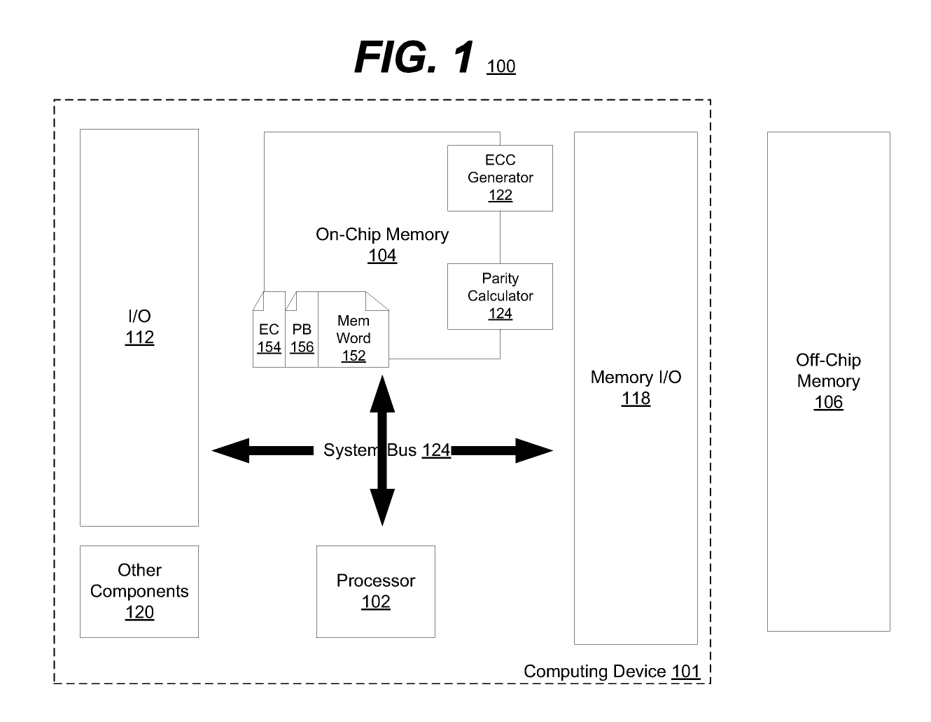

FIG. 1 is a block diagram of an example embodiment of a system 100 in accordance with the disclosed subject matter. In one embodiment, the system 100 may include a computing device 101. In various embodiments, the computing device 101 may include a device, such as, for example, system-on-a-chip (SoC), a laptop, desktop, workstation, personal digital assistant, smartphone, tablet, and other appropriate computers, etc. or a virtual machine or virtual computing device thereof. In various embodiments, the device 101 may be used by a user (not shown). In one embodiment, the system 101 may include off-chip memory 106.

In various embodiments, the device 101 may include a processor 102 configured to process one or more instructions and/or commands. The device 101 may include, in one embodiment, an on-chip memory 104 configured to store information either permanently, semi-permanently, and/or temporarily. In some embodiments, the on-chip memory 116 may store information for the processor 102 and/or other components 120.

In some embodiments, the device 101 may include a memory I/O interface 118 configured to communicate with the off-chip memory 106. In some embodiments, the system 101 may include one or more input-output (I/O) interfaces 112 configured to communicate with external (to the device 101) components via one or more predefined protocols (Ethernet, WiFi, Universal Serial Bus, etc.).

Further, in various embodiments, the device 101 may include a various other components 120, such as, for example, a display adapter configured to communicate with a monitor or other human-output device; an audio engine configured to process audio information; a media engine configured to process media, such as, for example video or audio information. It is understood that the above are merely a few illustrative examples to which the disclosed subject matter is not limited. In some embodiments, one or more of these components may be configured to communicate via a system bus 124. It is understood that the above are merely a few illustrative examples to which the disclosed subject matter is not limited.

In various embodiments, the memory 104 may be configured to store code, instructions, and/or data structures for use by the processor 102. In various embodiments, the memory 104 may be organized into substantially uniform portions or segments. In this context, these portions or segments may be referred to as “words” or “memory words” 152. In some embodiments, these words may include 64-bits of data or actual. In another embodiment, these words 152 may include 32-bits, 128-bits or other lengths of actual data.

In various embodiments, the processor 102 may be configured to read/write from/to the memory 104 in either whole words lengths (e.g., a full 64-bits, etc.) or in partial word lengths (e.g., 8-bits, 16-bits, etc.). In some embodiments, the majority of memory accesses may occur as full words. In such an embodiment, a full word memory access may be considered the most efficient. In another embodiment, the memory accesses may occur as partial writes.

Traditionally, to accomplish these partial writes, the processor 102 or the memory 104 may have been configured to read the full word 152 that includes the partial word portion, replace the desired partial portion, and then write the new word 152 as a full word write. In such an embodiment, the process of writing a partial word may have been fairly inefficient.

Further, as described above, in various embodiments, the memory 104 may employ some form of error-correcting code (ECC) 154 that allows for the detection and/or correction of a memory soft error. In this context, a “soft error” includes an error or flipping of a bit or bits within a memory word 152 that causes the data that is read to differ from the data that had been written (e.g., due to a broken wire or memory element, a spurious electrical charge, a cosmic ray, etc.). In various embodiments, a soft error may be corrected either by the memory 104 or by re-writing the correct data within the affected memory location or a different memory location. It is understood that the above is merely one illustrative example to which the disclosed subject matter is not limited. It is further understood that the occurrence of a soft error is not limited to just a data portion of a memory and may occur in other memory portions, such as, for example an ECC portion of the memory, etc.

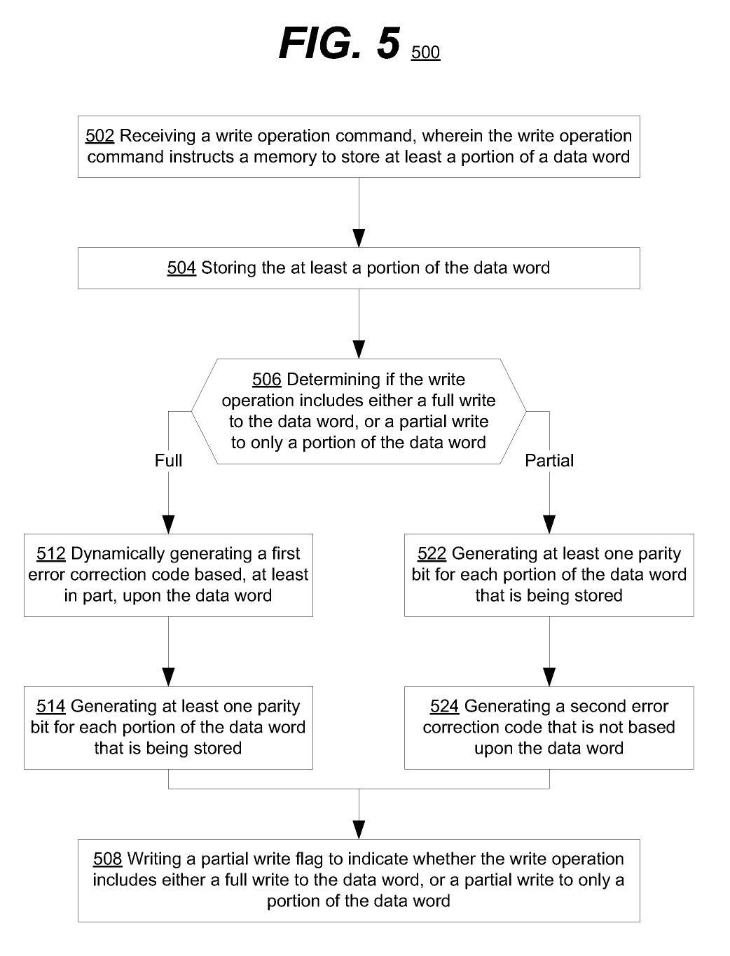

In some embodiments, the memory 104 may include an ECC generator 122 configured to generate the ECC 154 given a set of inputs. As described below, in various embodiments, the set of inputs provided to the ECC generator 122 may dynamically change based upon the type of write operation (full or partial) executed by the memory 104. In some embodiments, the ECC generator 122 may include a syndrome calculation engine (illustrated in FIG. 5). In another embodiment, the ECC generator 122 may be included by the processor 102.

In various embodiments, the memory 104 may be configured to only generate the ECC 154 during a full write to the memory word 152. In such an embodiment, the ECC 154 may be based upon the full word (e.g., 64-bits, etc.). In such an embodiment, if a partial word is written, the ECC 154 may be incorrect or may need to be recalculated. Such a recalculation may include or involve the reading of the full word 152, the modification of the partial portion, and the recalculation of the ECC 154 based upon the new full word. As described above, this may be undesirable. In the illustrated embodiment, various other encodings, data structures or schemes may be employed to provide error detection and/or correction while reducing the amount of overhead incurred by a partial word write.

In one embodiment, the memory 104 may include a parity bit generator or calculator 124 configured to generate parity bits 156 based upon the memory word 152. As described below, the memory word 152 may be sub-divided into portions and each portion may be associated with a particular parity bit or bits 156. In various embodiments, the parity calculator 124 may be configured to only generate parity bits 156 for the portions of the memory word 152 being written to. In such an embodiment, if a partial write operation occurs only a portion of the parity bits 156 may be re-calculated. However, if a full write operation occurs all of the parity bits 156 may be calculated. In various embodiments, the parity calculator 124 may be configured to calculate expected parity bits during the performance of a read operation. In another embodiment, the parity calculator 124 may be included by the processor 102.

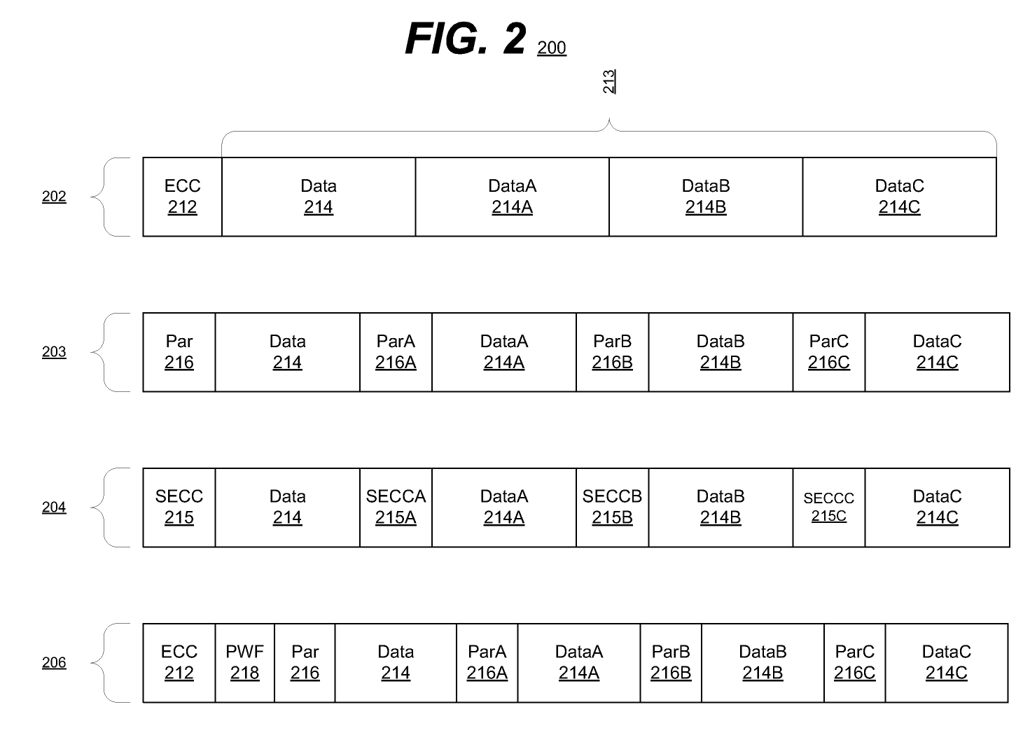

FIG. 2 is a block diagram of an example embodiment of a series 200 of data structures in accordance with the disclosed subject matter. It is understood that the above are merely a few illustrative examples to which the disclosed subject matter is not limited.

In one embodiment, the data structure 200 illustrates a simple structure that may be employed to store data. In the illustrated embodiment, the data word 213 is divided into four smaller data portions of data 213 (data 214, dataA 214A, dataB 214B and dataC 214C). In this context, the term “data 214” and similarly un-indexed versions of similar portions (e.g., Par 216, SECC 215, etc.) are used to refer to generic but similar portions of the memory. In the illustrated embodiment, every time the data word 213 is written to the memory (which stores the data word 213), the ECC 212 is computed.

Herein the term “data 214” refers to a generic data position (data 214, data 214A, dataB 214B or dataC 214C) and the term “data 213” refers to the entire data word (data 214, data 214A, dataB 214B and dataC 214C). In this context, the term “data” may refer to either what, in computer architecture jargon, is referred to as an “instruction” or “data”. That is the data may cause a processor to do something (an instruction) or may be used when the processor is doing something (data). In this context, this may include the case where the data is stored for future use by the processor. For example there may be multiple cases when a peripheral device may initiate a full or partial write to memory (e.g., a direct memory access (DMA), etc.) which will later be read by the processor. It is understood that the above is merely one illustrative example to which the disclosed subject matter is not limited.

In one embodiment, the data word 213 may include 32-bits of data or “actual data” that is used and of interest to the processor device making use of the data to perform an operation. In some embodiments, the ECC portion 214 may include a Hamming code. It is understood that the above is merely one illustrative example of an ECC to which the disclosed subject matter is not limited. In such an embodiment, the total number of bits for the ECC portion 214 may be determined based upon a function of the number of covered bits in the memory word based on a well-known calculation.

As described above, in various embodiments, if a partial portion of data 214 (e.g., DataB 214B, etc.) is written to the data structure 202, the ECC portion 212 may be recalculated based upon the new data word 213. In such an embodiment, this may involve the reading and re-writing of the entire data word 213.

Data structure 203 may include the data word 213, again subdivided into the four data portions 214. In such an embodiment, the data structure 203 may include four parity bits 216 (Par 216, ParA 216A, ParB 216B, and ParC 216C). In such an embodiment, each data portion 214 may be associated with a parity bit 216. As a data portion 214 is written to the data structure 203 the associated parity bit 216 may be computed and also written. For example if three data portions 214 are being written, three parity bits 216 would also be computed and written.

In such an embodiment, the parity bits 216 may allow for more efficient writing of the data word 213, even when a partial data word 213 is written. Likewise the number of bits used for the data word 213 may be limited to 36-bits (32-bits of the actual data word 213 and 4 bits for the parity bits 216). However, the parity bits 216 may only allow for the detection of an error and may not allow for the correction of the error (like ECC 212 may). It is understood that the above is merely one illustrative example to which the disclosed subject matter is not limited.

Data structure 204 may include the data word 213, again subdivided into the four data portions 214. In such an embodiment, the data structure 204 may include four smaller ECC portions 215. Each smaller ECC portion 215 (SECC 215, SECCA 215A, SECCB 215B, and SECCC 215C) may be associated with a respective data portion 214. In such an embodiment, each smaller ECC portion 215 may include less bits than the larger ECC 212 (e.g., 5 bits, etc.). This, in one embodiment, may bring the total size of the data structure 204 to 52 bits (32-bits of the actual data word 213 and 20 bits for the four 5-bit SECC fields 215) and a 64-bit data word embodiment would exceed 104 bits.

Data structure 206 may include the data word 213, again subdivided into the four data portions 214. However, in such an embodiment, each data portion 214 may be associated with a simple parity portion 216, as described above. In such an embodiment, as each data portion 214 is written to the data structure 206, the corresponding parity portion 216 may be calculated and stored. In such an embodiment, the calculation of a parity bit or bits 216 may be relatively computationally trivial (e.g., compared to the ECC Hamming code, etc.).

In one embodiment, the data structure 206 may also include an overall ECC code 212 that applies to the entire data word 213 and its corresponding parity bits 216. In such an embodiment, when the full word 213 is written the ECC code 212 may be computed. In another embodiment, the ECC code 212 may not be computed during a partial write (i.e. a write to less than the full word 213). In yet another embodiment, during a partial write the ECC 212 may be set to a predetermined known value. In yet another embodiment, during a partial write the ECC 212 may be computed using a predetermined known value (e.g., zero, etc.).

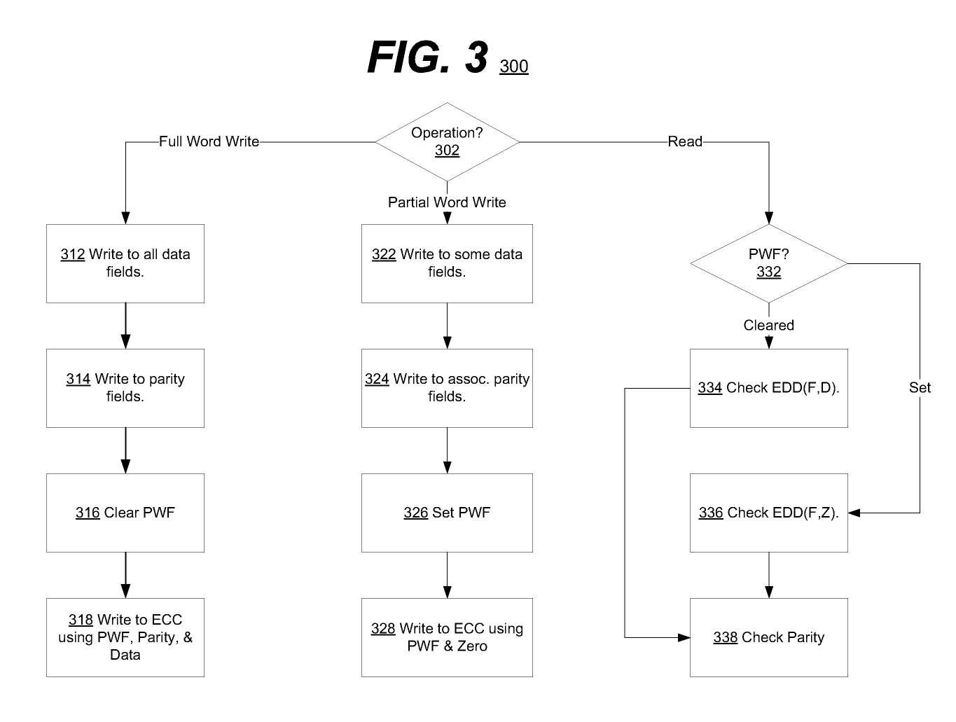

In various embodiments, the data structure 206 may include a partial write flag (PWF) 218. In such an embodiment, the PWF 218 may indicate whether or not a partial word or data portion 214 has been written to the data structure 206 since the last full word 213 was written. In such an embodiment, this may indicate whether or not the ECC 212 is valid or is set to a known or deterministic value. In another embodiment, this may indicate whether or not the parity bits 216 are valid. This process is described below in more detail in relation to FIG. 3.

In the illustrated embodiment, the data structure 206 may include 44 bits. 32-bits may be used for the actual data word 213. 4-bits may be used for the parity bits 216. The ECC 212 may include 7 bits, and the PWF 218 may include 1-bit. In such an embodiment, the data structure 206, which is a modified hybrid of the data structures 202 and 203, may provide or be configured to provide both error correction and detection while allowing partial writes with a reduced about of error bit computation and a smaller number of overall bits compared to data structure 204. In such an embodiment, the overhead or portion used to store information that is not the actual data 213 may be 27% for a 32-bit word. It is understood that the above is merely one illustrative example to which the disclosed subject matter is not limited.

In some embodiments, the ECC 212 may allow for coverage or error detection/correction of more bits than just the data word 213. For example in some embodiments, a 7-bit ECC 212 may allow for error detection and/or correction to up to 56 bits. Given that the data word 213 is only 32 bits, the ECC 212 may also cover or protect the 4 parity bits 216 and/or the PWF 218. The ECC 212 also may protect itself. It is understood that the above is merely one illustrative example to which the disclosed subject matter is not limited.

In various embodiments, the partial write flag 218 may be included within the “extra space” in an ECC check code 212. In some embodiments, an ECC code 212 capable of 32 data bits may include an excess capacity of 25 bits, and a code designed for 64 bits of data may include an excess protection capability of 56 bits. This excess can be used to cover the extra non-data bits in the hybrid protection method of data structure 206. In particular the partial write flag 218 may be covered since it may have no redundancy, as do the byte parity bits. In various embodiments, additional redundancy may be added by the additional fields or portions of variations of data structure.

In some embodiments, the PWF 218 may be susceptible to having an error, like any other bit. In various embodiments, some PWF 218 error scenarios may include:

The PWF 218 is supposed to be cleared, but a soft error causes it to set. In such an embodiment, the memory location may look like is had been written by a partial or byte-write operation. The memory protection logic, as described below, may be configured to only check that each byte or data portion 214 in the word had correct parity. In such an embodiment, the data portions 214 may have the correct parity as, in this embodiment, the error occurred only in the PWF 218. Speculatively, the logic may also compute the full word ECC error syndrome which would show an error that points to the PWF bit 218. This may, in one embodiment, be logged as a non-fatal memory error with the corrective action being to read, then write the location to restore all the correct check bits (e.g., ECC 212, parity 216, and PWF 218, etc.).

In another embodiment, PWF 218 is supposed to be set, but a soft error may causes it to be clear. In this case the word 213 has been partially written, so the ECC 212 check code is invalid, but the PWF 218 will indicate that there was no partial write. In this case the ECC error syndrome will likely be incorrect since at least the PWF bit 218 will have changed, but in addition the partial write of a data portion 214 bits will cause the ECC check to appear as if there has been as a multi-bit error and cause the syndrome to be inconclusive.

In one embodiment, the ECC check code value 212 may be written to a predetermined or deterministic value whenever a partial write occurs. In one such embodiment, if the memory protection logic caused an ECC check code 212 to be written as if the memory data word 213 was all zeros (to a deterministic value), and the PWF 218 is 1 or set, then the ECC 212 may be checked at the time of reading a partially written memory location even with a PWF soft-error.

In another embodiment, the ECC check (using a Zero data word 213+ECC 212+PWF 218) may be done in parallel with the normal ECC check (the actual data word 213+ECC 212+PWF 218). If the normal ECC syndrome shows an error, and the alternate ECC syndrome points to the PWF bit 218, and all the parity bits 216 are correct there may be a high likelihood that the PWF bit 218 has a soft error and that the ECC check error is non-fatal memory error with the corrective action being to read, then write the location to restore all the correct check bits (e.g., ECC 212, parity 216, and PWF 218, etc.) may be taken.

In yet another embodiment, the byte parity bits 216 may be included in the ECC check, using more of the extra room. In such an embodiment, the same dual ECC error syndrome calculations would be done (using a Zero data word 213+ECC 212+PWF 218 and the actual data word 213+ECC 212+PWF 218). This may have the additional feature of detecting that there was a bit-flip in a byte parity bit, which is non-fatal, instead of a data bit error, which would be fatal. The fatal error case would be when PWF 218 is set, one or more byte parity checks are incorrect, and the alternate ECC check produces a “no error” syndrome. In the absence of a multi-bit soft error the indication may be that there was a bit-flip in a data bit, but the stored ECC is not useful in finding the bit in error.

In such an embodiment, if the processor task that is using partial writes to modify the memory array is intolerant of that type of error then the data protection may include some support from the processor task, for example using a secondary (duplicate) storage allocation which would be updated on every write, but would only be referenced on an uncorrectable error in the primary storage to provide the correct values, which would be restored in the primary storage. It is understood that the above is merely one illustrative example to which the disclosed subject matter is not limited. However, the need for this level of additional error protection may be minimal since most partial write situations involve temporary data buffering which has some over-arching error detection/correction mechanism, such as TCP/IP, etc.

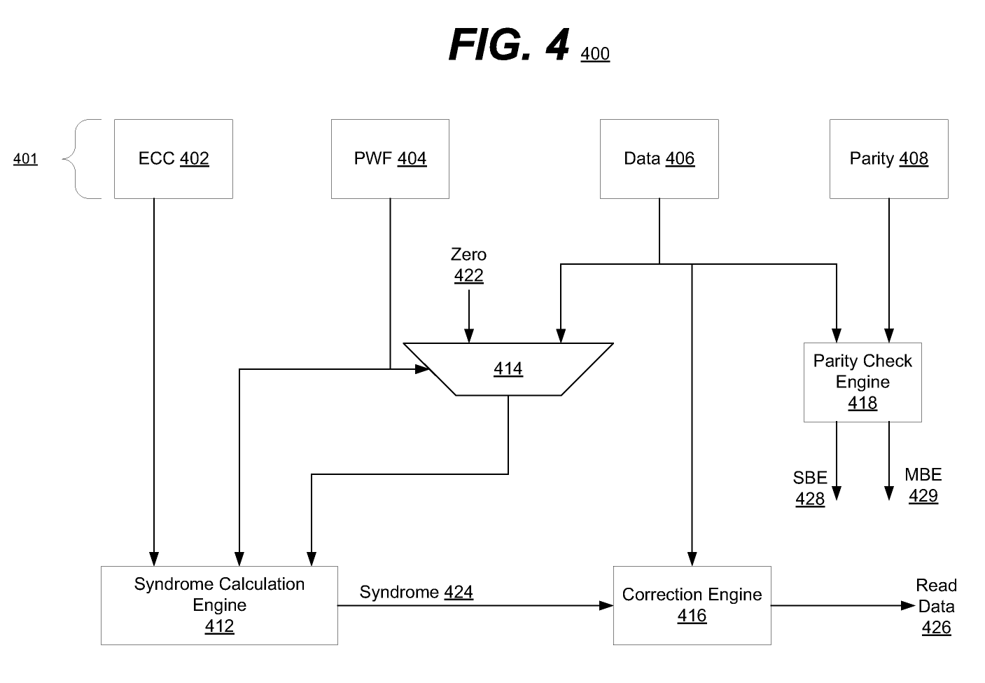

FIG. 3 is a flowchart of an example embodiment of a technique 300 in accordance with the disclosed subject matter. In various embodiments, this technique 300 may be employed to read data and to perform both full and partial writes to a memory. In various embodiments, the technique 300 may be employed by the systems or devices of FIGS. 1, 4, and/or 6. It is understood that the above are merely a few illustrative examples to which the disclosed subject matter is not limited.

Block 302 illustrates that, in one embodiment, a determination may be made as to what memory operation or access is to be performed. In the illustrated embodiment, the memory access may include a full word memory write, a partial word memory write, or a memory read. In such an embodiment, the memory read may be of the full word, although partial reads are contemplated. While the illustrated figure shows a sequence of operations, it is understood that in various embodiments, these operations may be performed in a different sequence. In yet another embodiment, the operations may be merged into a single step and performed substantially in parallel.

If a full data word write operation is being performed, Block 312 illustrates that, in one embodiment, the actual data provided by the write operation may be written to all of the data fields (e.g., all data portions 214 of FIG. 2). Block 314 illustrates that, in one embodiment, the value of the parity bits (e.g., parity fields 216 of FIG. 2) may be computed for each data portion, and those values written to the respective parity fields. Block 316 illustrates that, in one embodiment, the PWF may be cleared to indicate that the last write to the data word was indeed a full word write. Block 318 illustrates that, in one embodiment, the ECC value may be computed using the PWF, parity, and the actual data.

Conversely, if only a partial word write operation is being performed, Block 322 illustrates that, in one embodiment, the actual data provided by the write operation are written to the appropriate or target data fields (e.g., only a few of the data portions 214 of FIG. 2). In various embodiments, the operation itself may indicate which data portions (e.g., bytes of a 32-bit word, etc.) are to be written. Block 324 illustrates that, in one embodiment, the parity fields associated with the new data portions are calculated and written. In various embodiments, the non-target, non-written, or untouched data portions and respective parity bits may remain untouched or in their prior/current state. Block 326 illustrates that, in one embodiment, the PWF may be set to indicate that the last write to the data word was a partial word write. Block 328 illustrates that, in one embodiment, the ECC value may be computed using the PWF and a predetermined value for the data portion (e.g., a set of zero values, etc.). In another embodiment, the ECC may be set to a predetermined value (e.g., zeros, etc.). It is understood that the above are merely a few illustrative examples to which the disclosed subject matter is not limited.

If the memory operation is a read operation, Block 322 illustrates that, in one embodiment, a determination may be made as to whether or not the last or most current write to the memory location was a full or partial memory write. In the illustrated embodiment, the PWF may be checked. If the PWF indicates that the last write was a full word write, Block 334 illustrates that, in one embodiment, the EDD data may be check based upon the PWF and the actual data (and/or the parity bits). Conversely, if the PWF indicates that the last write was a partial word write, Block 336 illustrates that, in one embodiment, the EDD data may be check based upon the PWF and the predetermined value (e.g., zeros, etc.) (and/or the parity bits). Block 338 illustrates that, in one embodiment, the parity bits may be checked for each data portion.

FIG. 4 is a block diagram of an example embodiment of a system 400 in accordance with the disclosed subject matter. In various embodiments, the system 400 may be configured to test information or data as it is read from a memory. In such an embodiment, the data 406 may be retrieved from the memory and its veracity or quality may be assessed by the system 400. In various embodiments, the system 400 may also be configured to correct, at least partially, any incorrect or flipped bits of the data 406. In some embodiments, the checking process may also detect errors in other, non-data portions of the memory word. In such an embodiment, such errors may be side-band to the data access, but may be reported to the processor for possible remediation.

In one such embodiment, the system 400 may be configured to receive, during a read operation, the data 406, a number of parity bits 408, a partial write flag 404, and an error correction code (ECC) 402. As described above, the data 406 may be subdivided into portions and each portion may be associated with one or more parity bits 408. Likewise, as described above, the ECC 402 may include a Hamming code or other error correction code and may cover the data 406; the data and the PWF 404; the data 406, parity bits 408, and the PWF 404, or another combination of inputs as described above.

As described above, in one embodiment, there may be a trade-off between error correction (e.g., ECC/Hamming information), and simple error detection which only requires parity. In such an embodiment, the trade-off may include that the action of a partial write of the data in a memory word makes full word ECC non-functional. In such an embodiment, the PWF may be configured to capture that situation. For the duration of a partial write the only data protection may be a parity scheme that has the granularity of the amount to partial write possible, typically a byte.

In the illustrated embodiment, the system 400 may include a syndrome calculation engine 412 configured to compute or generate syndrome 424 based upon a series of inputs. In such an embodiment, the syndrome 424 may be configured to indicate whether or not the data 406 (or other portion of the memory word 401) is corrupt or in error.

As described above, in one embodiment, the computation of the syndrome 424 and proper expected ECC 402 may be based upon the partial-write-flag (PWF) 404. If the PWF 404 indicates that the last write was to the full memory word, the syndrome calculation engine 412 may receive as input the data 406, the ECC 402 and the PWF 404. Conversely, if the PWF 404 indicates that the last write was to only a part of the memory word, the syndrome calculation engine 412 may receive as input the ECC 402, the PWF 404, and a predefined placeholder data 422 (e.g., all zeros, etc.). The system 400 may include a selection device 414 (e.g., a multiplexer, etc.) to select between these two possible input sets. From the given inputs the syndrome calculation engine 412 may generate a syndrome 424.

In the illustrated embodiment, the system 400 may include a correction engine 416 configured to correct, if possible, any memory errors detected by the syndrome calculation engine 412. In such an embodiment, the correction engine 416 may receive as input the syndrome 424 and the data 406. In various embodiments, the correction engine 416 may be configured to correct only a limited number of bits. In such an embodiment, fi the number of bits in error exceeds the correction engine 416's capabilities or the syndrome 424 includes an unexpected result (e.g., indicates errors in bits not present, etc.), the correction engine 416'may be configured to take various remedial measures (e.g., throw an exception, generate an interrupt, etc.). In some embodiments, the correction engine 416 may receive input from the parity bits 408 or the output of the parity check engine 418. In various embodiments, the correction engine 416 may produce the read data 426 that is the result of the memory read operation.

In some embodiments, the system 400 may include a parity check engine 418. In various embodiments, the parity check engine may compare the data 406 to the parity bits 408. In such an embodiment, based upon this comparison or calculation, the parity check engine 418 may be configured to indicate whether or not a single-bit error (SBE) 428, a multi-bit error (MBE) 429, or no parity error occurred.

FIG. 5 is a flowchart of an example embodiment of a technique 500 in accordance with the disclosed subject matter. In various embodiments, the technique 500 may be used or produced by the systems such as those of FIG. 1, 4, or 6. Furthermore, portions of technique 500 may use or produce one or more of the data structure such as those of FIG. 2. Although, it is understood that the above are merely a few illustrative examples to which the disclosed subject matter is not limited. It is understood that the disclosed subject matter is not limited to the ordering of or number of actions illustrated by technique 500.

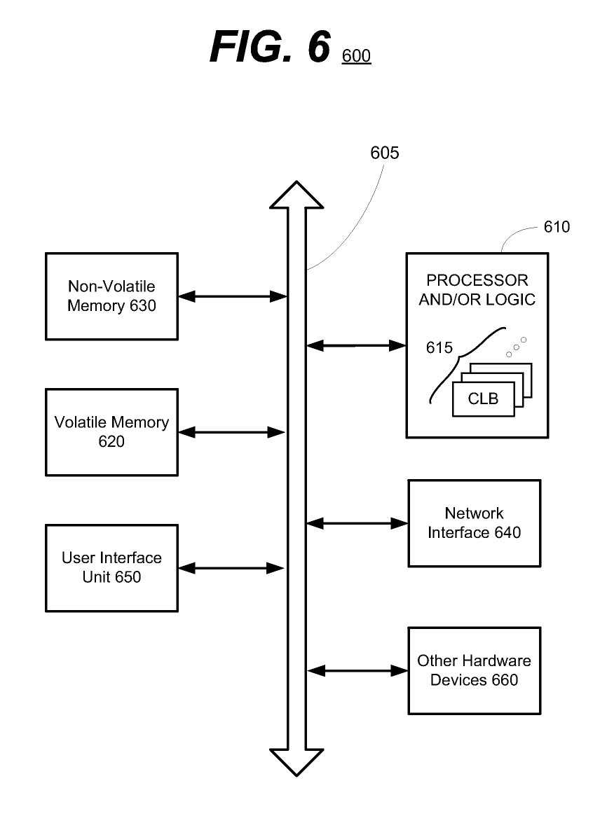

Block 502 illustrates that, in one embodiment, a write operation command may be received, as described above. In various embodiments, the write operation command may include an instruction for a memory to store at least a portion of a data word. In another embodiment, the write operation command may include an instruction for a memory to store a data word in its entirety, as described above. In various embodiments, one or more of the action(s) illustrated by this Block may be performed by the apparatuses or systems of FIG. 1 or 6, the processor and memories of FIG. 1 or 6, as described above.

Block 504 illustrates that, in one embodiment, at least a portion of the data word, as dictated by the write operation, may be stored. Block 506 illustrates that, in one embodiment, a determination may be made as to whether or not the write operation includes either a full write to the data word or a partial write to only a portion of the data word. In various embodiments, one or more of the action(s) illustrated by these Blocks may be performed by the apparatuses or systems of FIG. 1 or 6, the memories of FIG. 1 or 6, as described above.

Block 512 illustrates that, in one embodiment, if the write operation includes a full write, a first error correction code based, at least in part, upon the data word may be generated, as described above. In another embodiment, the first error correction code may be based off, at least in part, the data word, the partial write flag, the parity bits, and/or the error correction code itself, as described above. In some embodiments, the first error correction code may be generated based upon a first set of inputs, such as, for example, the data word, the partial write flag, the parity bits, and/or the error correction code itself, or a combination thereof, as described above. In various embodiments, one or more of the action(s) illustrated by these Blocks may be performed by the apparatuses or systems of FIG. 1 or 6, the memories of FIG. 1 or 6, or the error correction code generator of FIG. 1, as described above.

Block 514 illustrates that, in one embodiment, if the write operation includes a full write, a parity bit may be generated for each portion of the data word that is being stored, as described above. In various embodiments, this may occur prior to the actions of Block 512, as described above. In various embodiments, one or more of the action(s) illustrated by these Blocks may be performed by the apparatuses or systems of FIG. 1 or 6, the memories of FIG. 1 or 6, or the parity generator of FIG. 1, as described above.

Block 522 illustrates that, in one embodiment, if the write operation includes a partial write, a parity bit may be generated for each portion of the data word that is being stored, as described above. In such an embodiment, parity bits may be generated for some portions of the data word but not others, depending upon which portions are the subject of the partial write, as described above. In various embodiments, Blocks 514 and 522 may be merged and occur prior to or regardless of the outcome of Block 506, as described above. In various embodiments, one or more of the action(s) illustrated by these Blocks may be performed by the apparatuses or systems of FIG. 1 or 6, the memories of FIG. 1 or 6, or the parity generator of FIG. 1, as described above.

Block 524 illustrates that, in one embodiment, if the write operation includes a partial write, a second error correction code may be generated, as described above. In some embodiments, the second error correction code may not be based upon the data word, as described above. In another embodiment, the second error correction code may be based upon, at least in part, the partial write flag, as described above. In some embodiments, the second error correction code may be generated based upon a second set of inputs, such as, for example, the partial write flag, as described above. In various embodiments, one or more of the action(s) illustrated by these Blocks may be performed by the apparatuses or systems of FIG. 1 or 6, the memories of FIG. 1 or 6, or the error correction code generator of FIG. 1, as described above.

Block 508 illustrates that, in one embodiment, a partial write flag may be written, as described above. In various embodiments, the partial write flag may indicate whether or not the write operation dictated either a full write to the data word or a partial write to only a portion of the data word, as described above. In various embodiments, one or more of the action(s) illustrated by these Blocks may be performed by the apparatuses or systems of FIG. 1 or 6, or the memories of FIG. 1 or 6, as described above

FIG. 6 is a schematic block diagram of an information processing system 600 which may include semiconductor devices formed according to principles of the disclosed subject matter.

Referring to FIG. 6, an information processing system 600 may include one or more of devices constructed according to the principles of the disclosed subject matter. In another embodiment, the information processing system 600 may employ or execute one or more techniques according to the principles of the disclosed subject matter.

In various embodiments, the information processing system 600 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 600 may be used by a user (not shown).

The information processing system 600 according to the disclosed subject matter may further include a central processing unit (CPU), processor or logic 630. In some embodiments, the processor 610 may include one or more functional unit blocks (FUBs) or combinational logic blocks (CLBs) 615. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 600 according to the disclosed subject matter may further include a volatile memory 620 (e.g., a Random Access Memory (RAM), etc.). The information processing system 600 according to the disclosed subject matter may further include a non-volatile memory 630 (e.g., a hard drive, an optical memory, a NAND or Flash memory, etc.). In some embodiments, either the volatile memory 620, the non-volatile memory 630, or a combination or portions thereof may be referred to as a “storage medium”. In various embodiments, the memories 620 and/or 630 may be configured to store data in a semi-permanent or substantially permanent form.

In various embodiments, the information processing system 600 may include one or more network interfaces 640 configured to allow the information processing system 600 to be part of and communicate via a communications network. Examples of a Wi-Fi protocol may include, but are not limited to: Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to: IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 600 according to the disclosed subject matter may further include a user interface unit 650 (e.g., a display adapter, a haptic interface, a human interface device, etc.). In various embodiments, this user interface unit 650 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 600 may include one or more other hardware components or devices 660 (e.g., a display or monitor, a keyboard, a mouse, a camera, a fingerprint reader, a video processor, etc.). It is understood that the above are merely a few illustrative examples to which the disclosed subject matter is not limited.

The information processing system 600 according to the disclosed subject matter may further include one or more system buses 605. In such an embodiment, the system bus 605 may be configured to communicatively couple the processor 610, the memories 620 and 630, the network interface 640, the user interface unit 650, and one or more hardware components 660. Data processed by the CPU 610 or data inputted from outside of the non-volatile memory 610 may be stored in either the non-volatile memory 610 or the volatile memory 640.

The semiconductor devices described above may be encapsulated using various packaging techniques. For example, semiconductor devices constructed according to principles of the present inventive concepts may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. An apparatus comprising:
a data word storage configured to store:
a word of data, wherein the word of data is subdivided into portions of data,
a plurality of parity bits, each parity bit associated with a respective portion of data, and
a partial write flag configured to indicate whether or not a previous write operation was a full write to the word of data or a partial write to the word of data;
an error correction code generator configured to dynamically generate an error correction code (ECC) during a write operation to the data word storage, wherein the error correction code generator is configured to:
if the write operation includes a full write to the word of data, generate a first error correction code based, at least in part, upon the word of data, the plurality of parity bits, and the partial word flag, and
if the write operation includes a partial write to the word of data, generate a second error correction code.

2. The apparatus of claim 1, wherein the error correction code generator is configured to, if the write operation includes a partial write to the word of data, maintain the second error correction code until a subsequent full write to the word of data occurs.

3. The apparatus of claim 1, wherein the error correction code generator is configured to generate the second error correction code based, at least in part, upon the partial write flag.

4. The apparatus of claim 1, wherein the error correction code generator is configured to generate the second error correction code based, at least in part, upon the partial write flag and a predefined value.

5. The apparatus of claim 1, wherein the data word storage is configured to store:
the error correction code, and
wherein the parity bits are interleaved with the portions of the word of data.

6. The apparatus of claim 1, wherein the apparatus is configured to, when performing a read operation on the word of data,
dynamically determine, based upon the partial write flag, whether to perform error detection primarily based upon the error correction code or primarily based upon the plurality of parity bits.

7. The apparatus of claim 1, wherein the apparatus is configured to, if the partial write flag indicates that the previous write operation was a full write to the word of data, compute a syndrome based, at least in part, upon the word of data; and
if the partial write flag indicates that the previous write operation was a partial write to the word of data, compute a syndrome based, at least in part, upon a predefined value.

8. The apparatus of claim 1, wherein the apparatus is configured to provide a full word of data error correction code protection when the previous write operation was a full write to the word of data; and
provide parity protection to the portions of the word of data when the previous write operation was a partial write to the word of data.

9. The apparatus of claim 1, wherein the error correction code is configured to provide for check code providing single error correction and double error detection (SECDED).

10. The apparatus of claim 1, wherein the error code correction generator is configured to, if the write operation includes a partial write to only a portion of the word of data, not modify a previously generated error correction code; and
wherein the partial write flag is configured to indicate whether or not the error correction code is valid.

11. A method comprising:
receiving a write operation command, wherein the write operation command instructs a memory to store at least a portion of a data word;
storing the at least a portion of the data word, wherein the data word is subdivided into portions of data;
determining if the write operation includes either a full write to the data word, or a partial write to only a portion of the data word;
if the write operation includes a full write to the data word, dynamically generating a first error correction code based upon, at least, the data word;
if the write operation includes a partial write to the data word, generating at least one parity bit for each portion of the data word that is being stored; and
writing a partial write flag to indicate whether the write operation includes either a full write to the data word, or a partial write to only a portion of the data word.

12. The method of claim 11, further including, if the write operation includes a partial write to the data word, generating a second error correction code that is not based upon the data word.

13. The method of claim 11, further including performing a read operation on the data word, wherein performing the read operation includes:
dynamically determining, based upon the partial write flag, whether to check a correctness of the data word based primarily upon the error correction code or primarily upon a plurality of parity bits.

14. The method of claim 11, further including performing a read operation on the data word, wherein performing the read operation includes:
if the partial write flag indicates that a previous write operation was a full write to the data word, computing a syndrome based, at least in part, upon the data word; and
if the partial write flag indicates that the previous write operation was a partial write to the data word, computing a syndrome based, at least in part, upon the partial write flag.

15. The method of claim 14, wherein performing the read operation includes:
if the partial write flag indicates that a previous write operation was a full write to the data word, computing a syndrome based, at least in part, upon the data word, the error correction code, a plurality of parity bits, and the partial write flag.

16. The method of claim 11, further comprising:
providing full data word error correction code protection when a previous write operation was a full write to the data word; and
providing parity protection to the portions of data when the previous write operation was a partial write to the data word.

17. A system comprising:
a processor configured to execute one or more instructions and employ one or more data structures; and
a memory configured to store the one or more data structures in data words, wherein each data word is subdivided into portions of data,
wherein the memory includes:
an error correction code generator configured to dynamically generate an error correction code (ECC) associated with the data word during a write operation, wherein the error correction code generator is configured to:
if the write operation includes a full write to a data word, generate a first error correction code based upon a first set of inputs, and
if the write operation includes a partial write to only a portion of the data word, generate a second error correction code based upon a second set of inputs,
a party bit generator configured to generate a plurality of parity bits, each parity bit associated with a respective portion of data, and
a memory storage configured to store, for each data word:
the respective data word, the error correction code, the party bits, and a partial write flag configured to indicate whether or not a previous write operation was a full write of the data word or a partial write of the data word.

18. The system of claim 17, wherein the error correction code generator is configured to generate the first error correction code based, at least in part, upon the data word, the parity bits, and the partial write flag, and
the second error correction code based, at least in part, upon the partial write flag and a predefined value and not the data word.

19. The system of claim 17, wherein the memory is configured to, when performing a read operation of the word of data,
dynamically determine, based upon the partial write flag, whether to perform error detection primarily based upon the error correction code or primarily based upon the plurality of parity bits.

20. The system of claim 17, wherein the memory is configured to, if the partial write flag indicates that the previous write operation was a full write, compute a syndrome based, at least in part, upon an entirety of the data word; and
if the partial write flag indicates that the previous write operation was a partial write, compute a syndrome based, at least in part, upon the partial write flag.
